(19) United States
(12) Patent Application Publication
(10) Pub. No.: US 2023/0161339 A1
(43) Pub. Date: May 25, 2023

(54) UNMANNED AERIAL VEHICLE REMOTE CONTROL DEVICE, UNMANNED AERIAL VEHICLE REMOTECONTROL SYSTEM, UNMANNED AERIAL VEHICLE REMOTE CONTROL METHOD, AND NON-TRANSITORYCOMPUTER READABLE MEDIUM

(71) Applicant: NEC Corporation, Minato-ku, Tokyo (JP)

(72) Inventor: Masamitsu TAKAHASHI, Tokyo (JP)

(73) Assignee: NEC Corporation, Minato-ku, Tokyo (JP)

(21) Appl. No.: 17/919,776

(22) PCT Filed: Apr. 16, 2021
(86) PCT No.: PCT/JP2021/015756

§ 371 Date: Oct. 19, 2022

(30) Foreign Application Priority Data
Apr. 24, 2020 (JP) 2020-077542

(51) Int. Cl. G05D 1/00; B64C 39/02; B64U 10/00

(52) U.S. Cl. CPC G05D 1/0016; B64C 39/024; B64U 10/00; B64U 2201/20

(57) ABSTRACT

To provide an unmanned aerial vehicle remote control device, etc., capable of remotely controlling an unmanned aerial vehicle without using an operation wand and its guide mechanism. An unmanned aerial vehicle remote control device includes a gesture recognition means that recognizes a gesture of an operator's hand based on an image taken by a camera that includes the operator's hand, a control command specification means that specifies a control command to which the gesture of the operator's hand recognized by the gesture recognition means is associated, and a communication means that transmits the control command specified by the control command specification means to the unmanned aerial vehicle.

### TECHNICAL FIELD

The present disclosure relates to unmanned aerial vehicle remote control device, unmanned aerial vehicle remote control system, unmanned aerial vehicle remote control method, and non-transitory computer readable medium.

### BACKGROUND ART

A remote control device for remotely controlling unmanned aerial vehicle (drone) is known (See, e.g., Patent Literature 1). The remote control device is equipped with an operation wand that is grasped and operated by an operator and a guide mechanism that guides a movement of the operation wand. A marker that will be taken by an infrared camera is attached to the operation wand. According to this remote control device, the movement of the marker is measured by the principle of triangulation based on an image taken by the infrared camera to generate the three-dimensional time-series position information of the operation wand. Then, by generating an instruction for controlling the unmanned aerial vehicle based on the generated three-dimensional time-series position information and transmitting the generated instruction to the unmanned aerial vehicle, the unmanned aerial vehicle can be controlled remotely.

### CITATION LIST

### Patent Literature

Patent Literature 1: Japanese Unexamined Patent Application Publication No. 2019-142290

### SUMMARY OF INVENTION

### Technical Problem

However, in Patent Literature 1, there is a problem that the operation wand and its guide mechanism must be used to remotely operate the unmanned aerial vehicle, and their preparation and operation are costly.

In view of the above problems, it is an object of the present disclosure to provide an unmanned aerial vehicle remote control device, an unmanned aerial vehicle remote control system, an unmanned aerial vehicle remote control method and a recording medium that can remotely controlling an unmanned aerial vehicle without using an operation wand and its guide mechanism.

### Solution to Problem

An unmanned aerial vehicle remote control device according to a first example aspect includes: a gesture recognition means for recognizing a gesture of an operator's hand based on an image taken by a camera including the operator's hand; a control command specification means for specifying a control command to which the gesture of the operator's hand recognized by the gesture recognition means is associated; and a communication means for transmitting the control command specified by the control command specification means to an unmanned aerial vehicle.

An unmanned aerial vehicle remote control system according to a second example aspect includes: a camera; an unmanned aerial vehicle that receives a control command and is controlled based on the received control command; a gesture recognition means for recognizing a gesture of an operator's hand based on an image taken by a camera including the operator's hand; a control command specification means for specifying a control command to which the gesture of the operator's hand recognized by the gesture recognition means is associated; and a communication means for transmitting the control command specified by the control command specification means to an unmanned aerial vehicle.

An unmanned aerial vehicle remote control method according to a third example aspect includes: a gesture recognition step that recognizes a gesture of an operator's hand based on an image taken by a camera including the operator's hand; a control command specification step that specifies a control command to which the gesture of the operator's hand recognized by the gesture recognition step is associated; and a communication step that transmits the control command specified by the control command specification step to an unmanned aerial vehicle.

A non-transitory computer readable medium (according to a forth example aspect) storing a program for causing an electronic device with at least one processor to execute: a gesture recognition processing that recognizes a gesture of an operator's hand based on an image taken by a camera including the operator's hand; a control command specification processing that specifies a control command to which the gesture of the operator's hand recognized by the gesture recognition processing is associated; and a communication processing that transmits the control command specified by the control command specification processing to an unmanned aerial vehicle.

### Advantageous Effects of Invention

The present disclosure provides an unmanned aerial vehicle remote control device, an unmanned aerial vehicle remote control system, an unmanned aerial vehicle remote control method and a recording medium that can remotely controlling an unmanned aerial vehicle without using an operation wand and its guide mechanism.

### BRIEF DESCRIPTION OF DRAWINGS

FIG. 1 is a schematic diagram of an unmanned aerial vehicle remote control device 10;

FIG. 2 is a flowchart of an example of the operation (unmanned aerial vehicle remote control processing) of the unmanned aerial vehicle remote control device 10;

FIG. 3 is a block diagram showing the configuration of the drone remote control system 1 according to Embodiment 2;

FIG. 4 shows examples of a gesture of an operator's hand recognized by the gesture recognition unit 12b;

FIG. 5 is a flowchart of an example of operation (a drone remote operation processing) of the drone remote control device 10; and

FIG. 6 is a sequence diagram showing the operation of the drone remote control system 1.

### EXAMPLE EMBODIMENT

### Embodiment 1

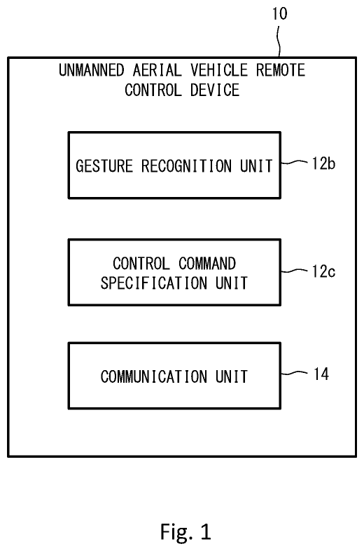

First, a configuration example of an unmanned aerial vehicle remote control (operation) device 10 constituting an unmanned aerial vehicle remote control (operation) system of Embodiment 1 will be described using FIG. 1.

FIG. 1 is a schematic diagram of the unmanned aerial vehicle remote control device 10.

As shown in FIG. 1, the unmanned aerial vehicle remote control device 10 includes a gesture recognition unit 12b that recognizes a gesture of an operator's hand based on an image taken by a camera that includes the operator's hand, a control command specification unit 12c that specifies a control command to which the gesture of the operator's hand recognized by the gesture recognition unit 12b is associated, and a communication unit 14 that transmits the control command specified by the control command specification unit 12c to a unmanned aerial vehicle.

Next, an example of an operation of the unmanned aerial vehicle remote control device 10 of the above configuration will be described.

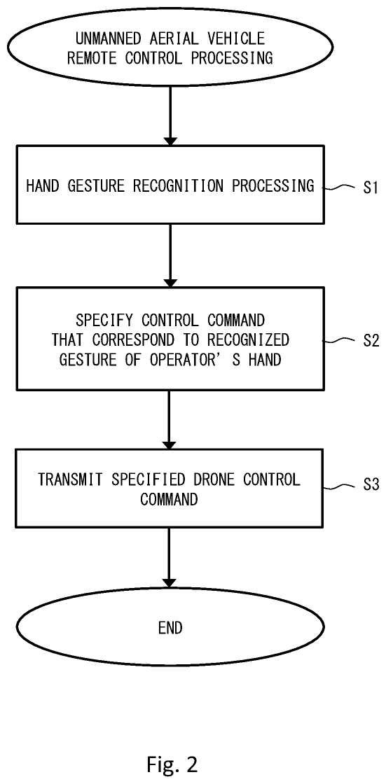

FIG. 2 is a flowchart of an example of the operation (an unmanned aerial vehicle remote control processing) of the unmanned aerial vehicle remote control device 10.

First, the gesture recognition unit 12b recognizes a gesture of an operator's hand based on an image including the operator's hand taken by a camera (step S1).

Next, the control command specification unit 12c specifies a control command to which the gesture of the operator's hand recognized in step S1 is associated (step S2).

Next, the communication unit 14 transmits the control command specified in step S2 to an unmanned aerial vehicle (step S3).

As described above, according to Embodiment 1, the unmanned aerial vehicle can be remotely controlled by the gesture of the operator's hand without using the operation wand and its guide mechanism.

### Embodiment 2

Hereafter, the unmanned aerial vehicle remote control (operation) system will be described in detail as Embodiment 2 of the present disclosure. Hereafter, a drone remote control system will be used as the unmanned aerial vehicle remote control system. Hereafter, it is described as a drone remote control system 1. A drone control command specification unit is used as the control command specification unit 12c. Hereafter, it is described as a drone control command specification unit 12c.

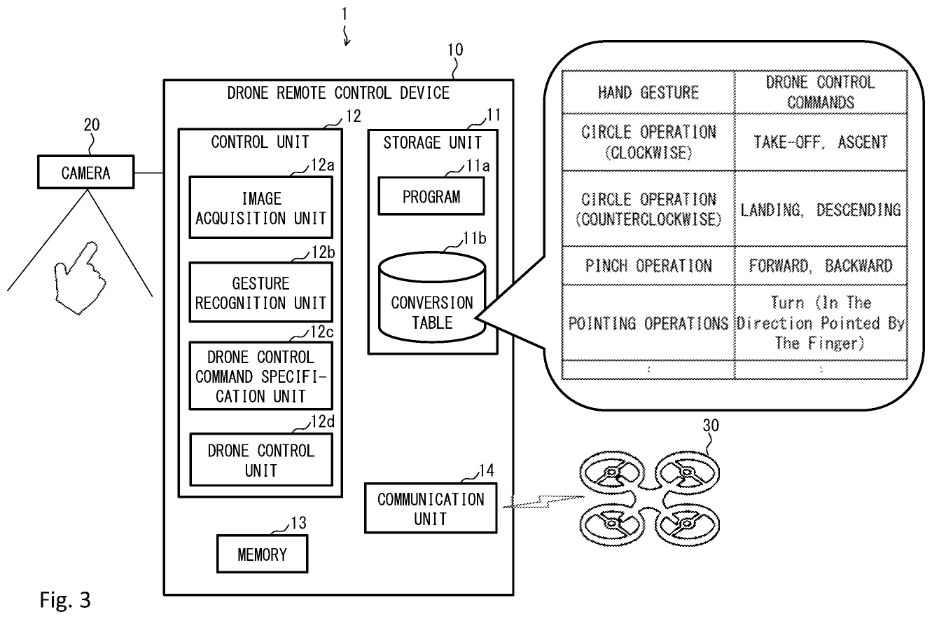

FIG. 3 is a block diagram showing a configuration of the drone remote control system 1 according to Embodiment 2.

The drone remote control system 1 is a system for remotely controlling (operating) a drone by a gesture of an operator's hand. The drone remote control system 1 includes a drone remote control device 10, a camera 20, and a drone 30.

First, a configuration example of the drone remote control device 10 will be described.

As shown in FIG. 3, the drone remote control device 10 includes a storage unit 11, a control unit 12, a memory 13, and a communication unit 14.

The storage unit 11 is, for example, a non-volatile storage unit such as a hard disk drive or ROM. In the storage unit 11, a program 11a and a conversion table 11b are stored.

The program 11a is a program executed by the control unit 12 (processor). Hand gestures and drone control commands are stored (registered) in the conversion table 11b in association with each other.

The control unit 12 includes a processor (not shown). The processor is, for example, a central processing unit (CPU). There may be one or more processors. By executing the program 11a that is read from the storage unit 11 into the memory 13 (for example, RAM), the processor functions as an image acquisition unit 12a, a gesture recognition unit 12b, a drone control command specification unit 12c, drone control unit 12d. A part or all of these may be realized by hardware.

The image acquisition unit 12a acquires from the camera 20 an image (a distance image) including an operator's hand taken by the camera 20.

Based on the image acquired by the image acquisition unit 12a, the gesture recognition unit 12b executes a hand gesture recognition processing for recognizing a gesture (for example, a three-dimensional gesture) of an operator's hand. The hand gesture recognition processing described in Japanese Patent No. 5709228, for example, can be used, and therefore, its explanation is omitted.

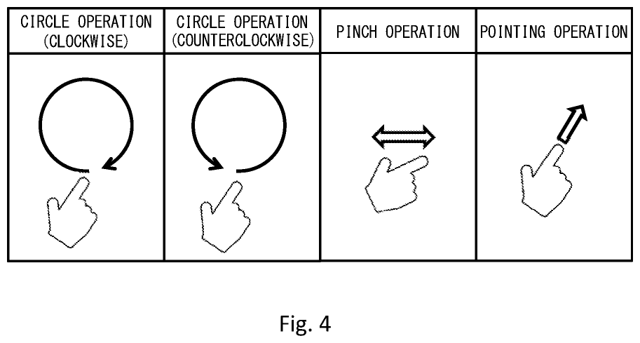

FIG. 4 shows examples of a gesture of an operator's hand recognized by the gesture recognition unit 12b.

As shown in FIG. 4, gestures of an operator's hand include, for example, a circle operation (clockwise), a circle operation (counterclockwise), a pinch operation and a pointing operation. The circle operation (clockwise) is a gesture of drawing a circle clockwise with an operator's hand (finger). The circle operation (counterclockwise) is a gesture of drawing a circle counterclockwise with an operator's hand (finger). The pinch operation is a gesture of picking with the thumb and index finger of an operator. The pointing operation is a gesture that points an operator's index finger in a specific direction.

The drone control command specification unit 12c converts a gesture of an operator's hand recognized by the gesture recognition unit 12b into a drone control command. Specifically, among the drone control commands stored in the storage unit 11 (the conversion table 11b), the drone control command specification unit 12c specifies a drone control command in which a gesture of an operator's hand recognized by the gesture recognition unit 12b is associated.

The drone control unit 12d transmits the drone control command specified by the control command specification unit 12c to the drone 30 via the communication unit 14.

The communication unit 14 is a communication device that performs wireless communication (for example, wireless communication via WiFi®) with the drone 30.

The camera 20 takes an image (images) that includes an operator's hand. The camera 20 is, for example, a time-of-flight (TOF) distance image camera. When the TOF distance image camera is used, only one camera 20 is required. The camera 20 is wired or wireless connected to the drone remote control device 10. The camera 20 is provided on an object other than the drone 30. The camera 20 may be separate from the drone remote control device 10 or built into the drone remote control device 10.

The drone 30 is an unmanned aerial vehicle (rotorcraft) that can be flown by remote control. The drone 30 is also known as a multicopter. The drone 30 includes a communication unit (not shown) and an aerial camera (not shown) for wireless communication (for example, wireless communication over WiFi) with the drone remote control device 10. Upon receiving a drone control command transmitted from the drone remote control device 10, the drone 30 executes an operation (take-off and landing, forward and backward, up and down, turning, somersault, etc.) corresponding to the received drone control command.

Next, an example of an operation of the drone remote control device 10 (a drone remote control processing) will be described.

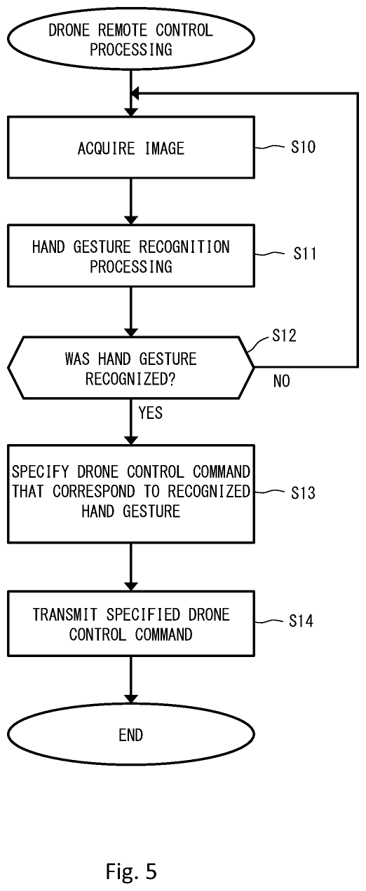

FIG. 5 is a flowchart of an example of operation (a drone remote control processing) of the drone remote control device 10.

First, the drone remote control device 10 (the image acquisition unit 12a) acquires from the camera 20 an image (a distance image) including an operator's hand taken by the camera 20 (step S10). Here, multiple images (multi-frame images) are acquired at different times.

Then, the drone remote control device 10 (the gesture recognition unit 12b) executes a hand gesture recognition processing for recognizing a gesture of the operator's hand based on the image acquired by the image acquisition unit 12a (step S11).

As a result of step S11, if the drone remote control device 10 did not recognize a gesture of the operator's hand (step S12: NO), the processing of steps S10 to S12 are repeatedly executed.

On the other hand, when a gesture of the operator's hand was recognized as a result of step S11 (step S12: YES), the drone remote control device 10 (the drone control command specification unit 12c) specifies a drone control command to which the gesture of the operator's hand recognized by the gesture recognition unit 12b is associated among the drone control commands stored in the storage unit 11 (the conversion table 11b) (step S13).

Then, the drone remote control device 10 (the drone control unit 12d) radio-transmits the drone control command specified in step S13 to the drone 30 via the communication unit 14 (step S14).

Next, an example of operation of the drone remote control system 1 of the above configuration will be described.

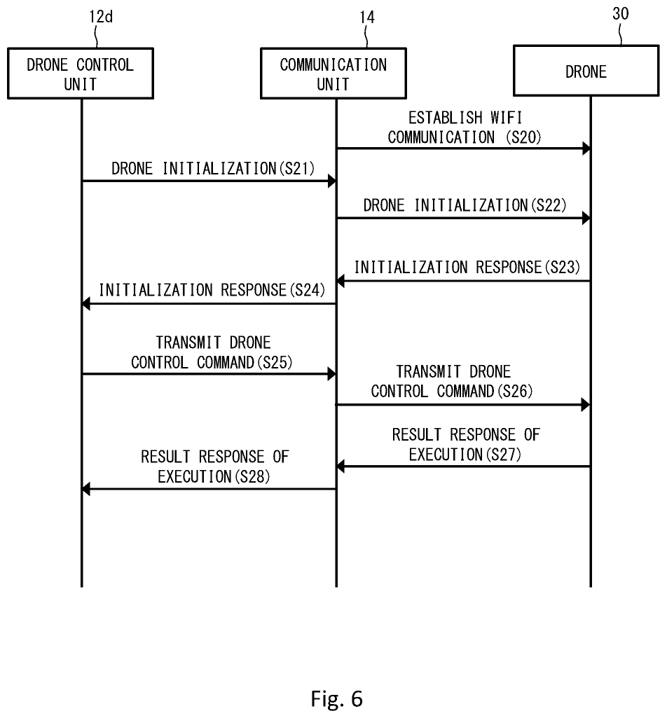

FIG. 6 is a sequence diagram showing the operation of the drone remote control system 1.

As shown in FIG. 6, first, the drone remote control device 10 (the communication unit 14) establishes WiFi communication with the drone 30 (step S20).

Then, the drone remote control device 10 (the drone control unit 12d) radio-transmits a drone initialization instruction for initializing the drone 30 to the drone 30 via the communication unit 14 (Step S21, S22).

Upon receiving the drone initialization instruction transmitted from the drone remote control device 10, the drone 30 executes an initialization and radio-transmits an initialization response indicating that the initialization is complete to the drone remote control device 10 (step S23).

Then, the drone remote control device 10 (the drone control unit 12d) receives the initialization response transmitted from the drone 30 via the communication unit 14 (Step S23, S24).

Next, when the drone remote control processing shown in FIG. 5 is executed, the drone remote control device 10 (the drone control unit 12d) radio-transmits the drone control command specified in step S13 to the drone 30 via the communication unit 14 (Step S25, S26).

Upon receiving the drone control command transmitted from the drone remote control device 10, the drone 30 executes the operation (take-off and landing, forward and backward, up and down, turning, somersault, etc.) corresponding to the received drone control command and wirelessly transmits an execution result response representing the execution result to the drone remote control device 10 (step S27).

Then, the drone remote control device 10 (the drone control unit 12d) receives the execution result response transmitted from the drone 30 via the communication unit 14 (Step S27, S28).

Thereafter, the drone remote control system 1 repeatedly executes the processing of steps S25 to S28 above every time the drone control processing shown in FIG. 5 is executed.

As described above, according to Embodiment 2, the drone 30 can be controlled remotely by a gesture of an operator's hand without using an operation wand and its guide mechanism, and without using or touching a control device such as a propo or a smartphone or tablet.

According to Embodiment 2, since there is no need to touch the operation equipment (for example, operation wand described in the background art), remote control of the drone 30 is possible even in situations where there are restrictions such as dirty hands or wearing gloves.

In addition, according to Embodiment 2, since the gesture of the operator's hand are recognized by the camera 20 provided independently of the drone 30, the camera (not shown) provided in the drone 30 is not occupied by the gesture recognition processing. This will allow the camera on the drone 30 to focus on surveillance and inspection by aerial shoot.

In addition, according to Embodiment 2, since it is possible to remotely control the drone 30 by the direction pointed by the finger of one hand or the movement of the fingertip, it is possible to do something else with the other hand. For example, while driving a vehicle, the drone 30 following the vehicle can be controlled remotely with a simple gesture of an operator's hand. This allows for safety checks and hazard predictions around the driving vehicle. Or this allows for check for traffic and empty parking spaces, scenery shots and driving records.

In addition, according to Embodiment 2, since a time-of-flight (TOF) type distance image camera is used as the camera 20, the drone 30 can be controlled remotely by a three-dimensional gesture of an operator's hand. For example, by pointing the operator's index finger in a specific direction, the drone 30 can be turned in the pointed direction.

Next, a variation is described.

In Embodiment 2, an example was described in which an operator remotely controls a drone 30 by a gesture of the operator's hand while visually observing the drone 30, but this is not limited to this. The drone 30 may be remotely controlled by a gesture of the operator's hand without visual observation. For example, by receiving the image (image information) taken by the camera transmitted from the drone 30 mounted with the camera and displaying it on the display unit (for example, a display device such as a liquid crystal display placed at the operator's hand), the operator can remotely control the drone 30 by a gesture while watching the image displayed on the display unit.

In Embodiment 2, the case of a single drone 30 controlled remotely by gestures was described as an example, but it is not limited to this case. For example, the remotely controlled drone 30 by a gesture may be multiple. For example, in step S14 (see FIG. 5), the same drone control command is transmitted (broadcast) to each of the multiple drones 30, so that the multiple drones 30 can perform the same movement (corresponding to the drone control command) by one gesture. For example, the same movements can be made while maintaining the relative distance of takeoff. This allows, for example, a demonstration of a swarm flight with multiple drones 30.

In the foregoing Embodiment 1, 2, a program can be stored and provided to a computer by use of various types of non-transitory computer-readable media. Non-transitory computer-readable media include various types of tangible storage media. Examples of such non-transitory computer-readable media include a magnetic recording medium (e.g., flexible disk, magnetic tape, hard-disk drive), a magneto-optical recording medium (e.g., magneto-optical disk), a CD-ROM (read-only memory), a CD-R, a CD-R/W, a DVD (digital versatile disc), and a semiconductor memory (e.g., mask ROM, PROM (programmable ROM), EPROM (erasable PROM), flash ROM, RAM (random-access memory)). Meanwhile, a program may be supplied to a computer by use of various types of transitory computer-readable media. Examples of such transitory computer-readable media include an electric signal, an optical signal, and an electromagnetic wave. A transitory computer-readable medium can supply a program to a computer via a wired communication line, such as an electric wire or an optical fiber, or via a wireless communication line.

All the numerical values shown in the above embodiment are examples, and it is of course possible to use a different suitable numerical value.

The above embodiment is merely illustrative in all respects. The description of the above embodiment does not construe the present invention in a restrictive manner. The invention can be carried out in a variety of other forms without departing from its spirit or main features.

Although the present disclosure has been described with reference to the example embodiments, the present disclosure is not limited by the above. The configuration and details of the present disclosure may be modified in various ways that will be understood by those skilled in the art within the scope of the disclosure.

This application claims priority on the basis of Japanese Patent Application No. 2020-077542, filed on Apr. 24, 2020, the entire disclosure of which is incorporated herein by reference.

### REFERENCE SIGNS LIST

1 DRONE REMOTE CONTROL SYSTEM
10 DRONE REMOTE CONTROL UNIT (UNMANNED AERIAL VEHICLE REMOTE CONTROL UNIT)
11 MEMORY
11a PROGRAM
11b CONVERSION TABLE
12 CONTROL UNIT
12a IMAGE ACQUISITION UNIT
12b GESTURE RECOGNITION UNIT
12c DRONE CONTROL COMMAND SPECIFICATION UNIT (CONTROL COMMAND SPECIFICATION UNIT)
12d DRONE CONTROL UNIT (UNMANNED AERIAL VEHICLE CONTROL UNIT)
13 MEMORY
14 COMMUNICATION UNIT
20 CAMERA
30 DRONE

What is claimed is:

1. An unmanned aerial vehicle remote control device comprising:
at least one memory storing instructions, and
at least one processor configured to execute the instructions to;
recognize a gesture of an operator's hand based on an image taken by a camera including the operator's hand;
specify a control command to which the gesture of the operator's hand recognized is associated; and
transmit the control command specified to an unmanned aerial vehicle.

2. The unmanned aerial vehicle remote control device according to claim 1, wherein
the at least one processor is further configured to execute the instructions to
acquire the image including the operator's hand taken by the camera; and
a storage unit in which hand gestures and control commands are stored in association with each other; wherein
recognize the gesture of an operator's hand based on the image acquired, and
specify, among the control commands stored in the storage unit, a control command to which the gesture of the operator's hand recognized is associated.

3. The unmanned aerial vehicle remote control device according to claim 1, wherein
the image taken by the camera, including the operator's hand, is a distance image, and
the at least one processor is further configured to execute the instructions to
recognize a three-dimensional gesture of an operator's hand based on the distance image.

4. The unmanned aerial vehicle remote control device according to claim 1, wherein
the camera is provided on an object other than the unmanned aerial vehicle.

5. The unmanned aerial vehicle remote control device according to claim 1, wherein
the unmanned aerial vehicle is a drone.

6. The unmanned aerial vehicle remote control device according to claim 1, wherein
The gesture of the operator's hand recognized include at least one of circle operation, pinch operation and pointing operation.

7. An unmanned aerial vehicle remote control system comprising:
a camera;
an unmanned aerial vehicle that receives a control command and is controlled based on the received control command;
a gesture recognition unit configured to recognize a gesture of an operator's hand based on an image taken by a camera including the operator's hand;
a control command specification unit configured to specify a control command to which the gesture of the operator's hand recognized is associated; and
a communication unit configured to transmit the control command specified to an unmanned aerial vehicle.

8. An unmanned aerial vehicle remote control method comprising:
a gesture recognition step that recognizes a gesture of an operator's hand based on an image taken by a camera including the operator's hand;
a control command specification step that specifies a control command to which the gesture of the operator's hand recognized by the gesture recognition step is associated; and
a communication step that transmits the control command specified by the control command specification step to an unmanned aerial vehicle.

9. (canceled)
